(19) United States
(12) Patent Application Publication
(10) Pub. No.: US 2013/0253813 A1
(43) Pub. Date: Sep. 26, 2013

(54) Method for Calculating Fuel Consumption During Driving and Driving Fuel Consumption Calculation System

(71) Applicants: Hsiu-Hsen Yao, Taipei City (TW); Yu-Chang Kuo, New Taipei City (TW); Tzyh-Jong Shang, New Taipei City (TW)

(72) Inventors: Hsiu-Hsen Yao, Taipei City (TW); Yu-Chang Kuo, New Taipei City (TW); Tzyh-Jong Shang, New Taipei City (TW)

(73) Assignee: INSTITUTE FOR INFORMATION INDUSTRY, Taipei (TW)

(21) Appl. No.: 13/492,101

(22) Filed: Jun. 8, 2012

(30) Foreign Application Priority Data
Mar. 20, 2012 (TW) 101109519

(51) Int. Cl. G06G 7/70

(52) U.S. Cl. 701/123

(57) ABSTRACT

A method for calculating fuel consumption during driving includes the steps of collecting a plurality of driving data, identifying the driving data to generate a plurality of driving movements, and obtaining fuel consumption by performing a calculating process based on the driving movements and a plurality of data stored in a driving movement fuel consumption database. Furthermore, a driving fuel consumption calculation system is also disclosed herein.

### RELATED APPLICATIONS

This application claims priority to Taiwan Application Serial Number 101109519, filed Mar. 20, 2012, which is herein incorporated by reference.

### BACKGROUND

1. Field of Invention

The embodiment of the present invention relates generally to a calculating method and system and, more particularly, to method for calculating fuel consumption during driving and a driving fuel consumption calculating system.

2. Description of Related Art

The price of the global crude oil exceeds 100 U.S. dollars in 2008 for the first with shortage of fuel of earth. Even through the price of the global crude oil tops out at 100 U.S. dollars and remains 90 U.S. dollars in 2012, but the expensive oil price impacts the transportation industry extremely and influences people driving private passenger car.

Hence, a requirement of calculating accurate fuel consumption occurs. However, a conventional global positioning system cannot provide driving movement data and driving behavior data, and therefore, the conventional global positioning system indeed cannot provide calculating accurate fuel consumption due to calculating accurate fuel consumption being obtained by calculation of driving movement data and driving behavior data. In addition, a conventional electronic control unit (ECU) cannot provide driving fuel consumption record analysis data, and driving movements are not correlated with fuel consumption data such that it is not accurate to calculate the fuel consumption.

In summary, the existing apparatus and techniques still have obvious defects and need further improvement. In order to solve the above problems, those skilled in the art are trying hard to find a solution, but no suitable method has been proposed.

### SUMMARY

Provided herein are a method for calculating fuel consumption during driving and a driving fuel consumption calculation system, so as to address the problems as follows. A conventional electronic control unit cannot provide driving fuel consumption record analysis data, and driving movements are not correlated with fuel consumption data such that it is not accurate to calculate the fuel consumption.

Thus, one aspect of the embodiment of the present invention is to provide a method for calculating fuel consumption during driving. The method comprises the steps of collecting a plurality of driving data; identifying the driving data to generate a plurality of driving movements; and obtaining fuel consumption by performing a calculating process based on the driving movements and a plurality of data stored in a driving movement fuel consumption database.

In one embodiment of the present invention, the method further comprises the steps of calculating the fuel consumption of the driving movements; and creating the data stored in the driving movement fuel consumption database based on the fuel consumption of the driving movements.

In another embodiment of the present invention, the driving data are selected from the group consisting of a vehicle speed, a vehicle acceleration, and a vehicle angular speed.

In yet another embodiment of the present invention, the step of collecting the driving data comprises the step of collecting the driving data by a on-board diagnostics, a global positioning system, or a driving movement sensing system.

In still another embodiment of the present invention, the data stored in the driving movement fuel consumption database are selected from the group consisting of vehicle fuel consumption data, driving movement fuel consumption of a driver, and fuel consumption data of a road driving.

In another aspect of the embodiment of the present invention, a driving fuel consumption calculation system is provided. The driving fuel consumption calculation system comprises a driving movement data collecting module, a driving movement identifying module, and a driving fuel consumption calculating module. In operation, the driving movement data collecting module is operable to collect a plurality of driving data. The driving movement identifying module is operable to identify the driving data to generate a plurality of driving movements. The driving fuel consumption calculating module is operable to obtain fuel consumption by performing a calculating process based on the driving movements and a plurality of data stored in a driving movement fuel consumption database.

In one embodiment of the present invention, the driving fuel consumption calculation system further comprises a driving movement fuel consumption calculating module and a driving movement fuel consumption creating module. In operation, the driving movement fuel consumption calculating module is operable to calculate the fuel consumption of the driving movements. The driving movement fuel consumption creating module is operable to create the data stored in the driving movement fuel consumption database based on the fuel consumption of the driving movements.

In another embodiment of the present invention, the driving data are selected from the group consisting of a vehicle speed, a vehicle acceleration, and a vehicle angular speed.

In yet another embodiment of the present invention, the driving data are collected by the driving movement data collecting module from a on-board diagnostics, a global positioning system, or a driving movement sensing system.

In still another embodiment of the present invention, the data stored in the driving movement fuel consumption database are selected from the group consisting of vehicle fuel consumption data, driving movement fuel consumption of a driver, and fuel consumption data of a road driving.

In summary, the embodiments of the present invention provide a method for calculating fuel consumption during driving and a driving fuel consumption calculation system, which address the problem as follows. A conventional electronic control unit cannot provide driving fuel consumption record analysis data. Driving movements are not correlated with fuel consumption data such that it is not accurate to calculate the fuel consumption.

### BRIEF DESCRIPTION OF THE DRAWINGS

The invention can be more fully understood by reading the following detailed description of the embodiments, with reference made to the accompanying drawings as follows:

FIG. 1A schematically shows a circuit block diagram of a driving fuel consumption calculating system according to one embodiment of the present invention; FIG. 1B-1 schematically shows a circuit block diagram of a driving fuel consumption calculating system according to another embodiment of the present invention; FIG. 1B-2 schematically shows a circuit block diagram of a driving fuel consumption calculating system according to yet another embodiment of the present invention; FIG. 1C schematically shows a circuit block diagram of a driving fuel consumption calculating system according to still another embodiment of the present invention; FIG. 1D-1 schematically shows a circuit block diagram of a driving fuel consumption calculating system according to yet another embodiment of the present invention; FIG. 1D-2 schematically shows a circuit block diagram of a driving fuel consumption calculating system according to still another embodiment of the present invention.

FIG. 2 schematically shows a flow diagram of a method for calculating fuel consumption during driving according to an embodiment of the present invention.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers indicate like components throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

As used herein, “around,” “about” or “approximately” shall generally mean within 20 percent, preferably within 10 percent, and more preferably within 5 percent of a given value or range. Numerical quantities given herein are approximate, meaning that the term “around,” “about” or “approximately” can be inferred if not expressly stated.

As used herein, the terms “comprising,” “including,” “having,” “containing,” “involving,” and the like are to be understood to be open-ended, i.e., to mean including but not limited to.

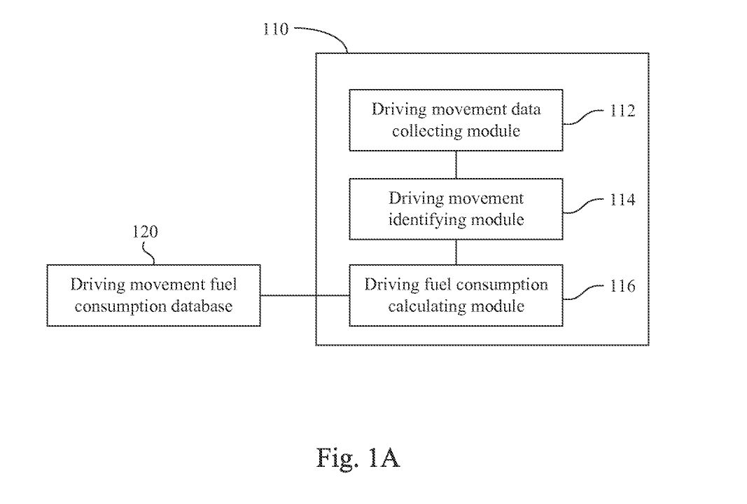

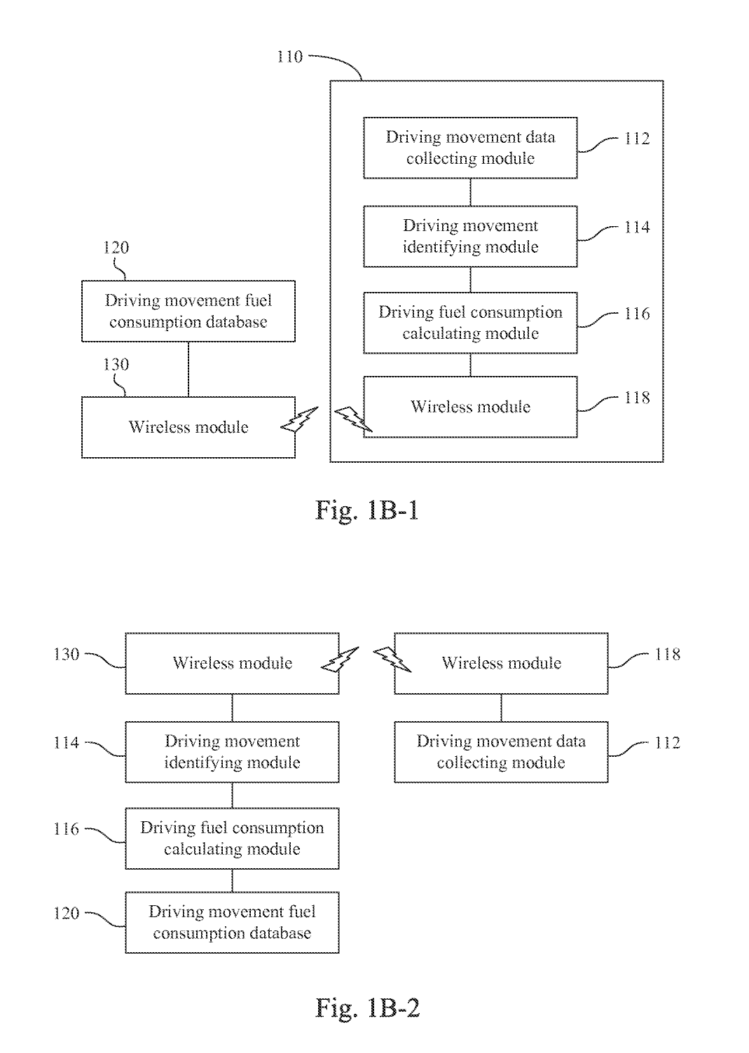

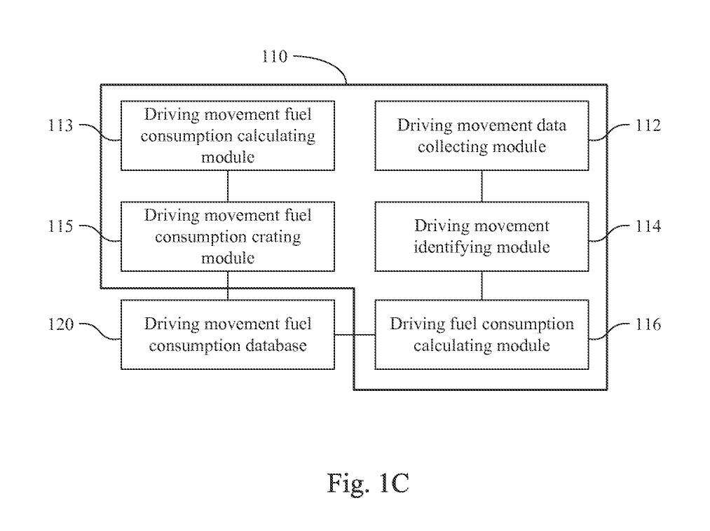

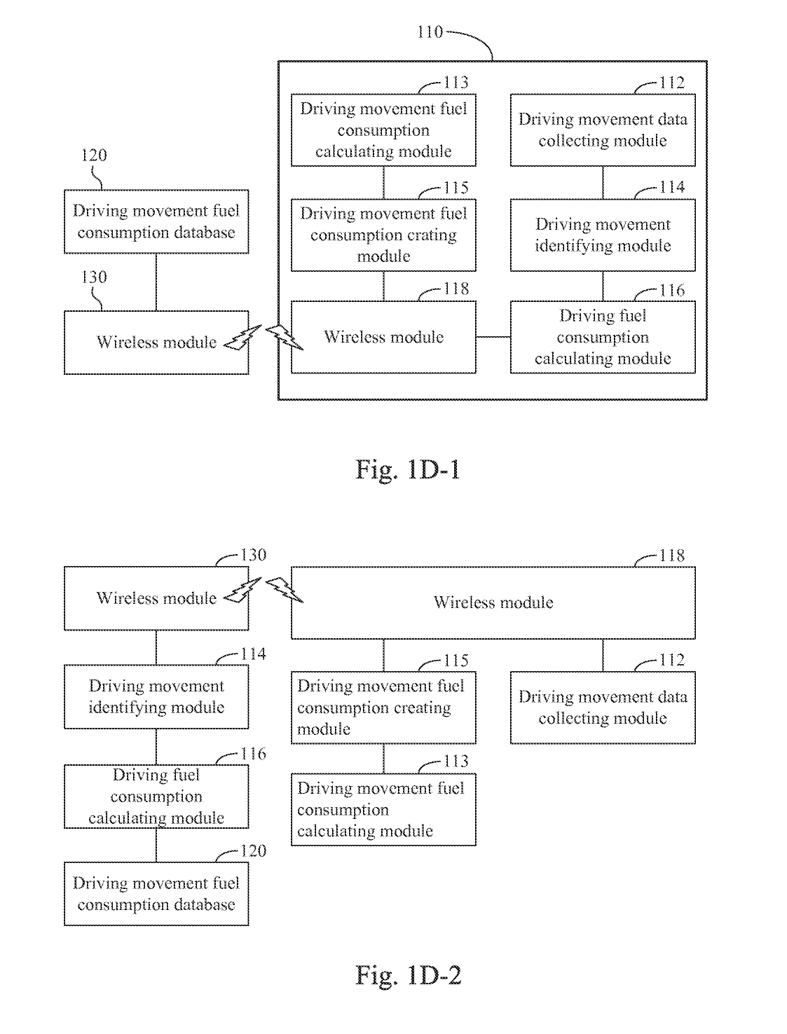

FIG. 1A schematically shows a circuit block diagram of a driving fuel consumption calculating system 110 according to one embodiment of the present invention. As shown in the figure, the driving fuel consumption calculation system 110 comprises a driving movement data collecting module 112, a driving movement identifying module 114, and a driving fuel consumption calculating module 116. In configuration, the driving movement identifying module 114 is electrically connected to the driving movement data collecting module 112, and the driving fuel consumption calculating module 116 is electrically connected to the driving movement identifying module 114.

In operation, the driving movement data collecting module 112 is operable to collect a plurality of driving data. The driving movement identifying module 114 is operable to identify the driving data to generate a plurality of driving movements. The driving fuel consumption calculating module 116 is operable to obtain fuel consumption by performing a calculating process based on the driving movements and a plurality of data stored in a driving movement fuel consumption database 120.

For example, the driving data are selected from the group consisting of a vehicle speed, a vehicle acceleration, and a vehicle angular speed. In one embodiment of the present invention, the driving data are collected by the driving movement data collecting module 112 from a on-board diagnostics, a global positioning system, or a driving movement sensing system.

The driving movement identifying module 114 can identify whether the driving movement is to brake a car, start a car, make a L/R turn, make a U turn, make a circular ring turn, stop a car, idle a car, change lane, accelerate a car, brake a car urgently, stop a car urgently, make a turn urgently, accelerate a car urgently, overtake another car, curb parking, or back a car by identifying a vehicle speed, a vehicle accelerate, and a vehicle angular speed when performing a driving movement based on an identification rule. Sequentially, owing to fuel consumption of the driving movements stored in the driving movement fuel consumption data beforehand such as fuel consumption of braking a car, fuel consumption of starting a car, fuel consumption of making a L/R turn, the driving fuel consumption calculating module 116 calculates fuel consumption during driving a car for a distance based on the driving movements and a plurality of data stored in the driving movement fuel consumption database 120.

Hence, the problems as follows can be solved. A conventional electronic control unit cannot provide driving fuel consumption record analysis data, and driving movements are not correlated with fuel consumption data such that it is not accurate to calculate the fuel consumption.

In one embodiment of the present invention, as shown in FIG. 1B-1, it schematically shows a circuit block diagram of a driving fuel consumption calculating system 110 according to another embodiment of the present invention. Compared with FIG. 1A, the driving fuel consumption calculation system 110 further comprises a wireless module 118. The wireless module 118 is electrically connected to the driving fuel consumption calculating module 116. The driving movement fuel consumption database 120 herein is electrically connected to wireless module 130 and not electrically connected to driving fuel consumption calculating module 116.

Compared with FIG. 1A, in operation, the driving fuel consumption calculating module 116 can connect to the wireless module 130 wirelessly through the wireless module 118 to obtain the data stored in the driving movement fuel consumption database 120 from the driving movement fuel consumption database 120. Sequentially, the driving fuel consumption calculating module 116 obtains fuel consumption by performing a calculating process based on the driving movements and a plurality of data. The method to calculate the fuel consumption is recited in the description of FIG. 1A, and accordingly, a detail description regarding the present calculating method is omitted herein for the sake of brevity.

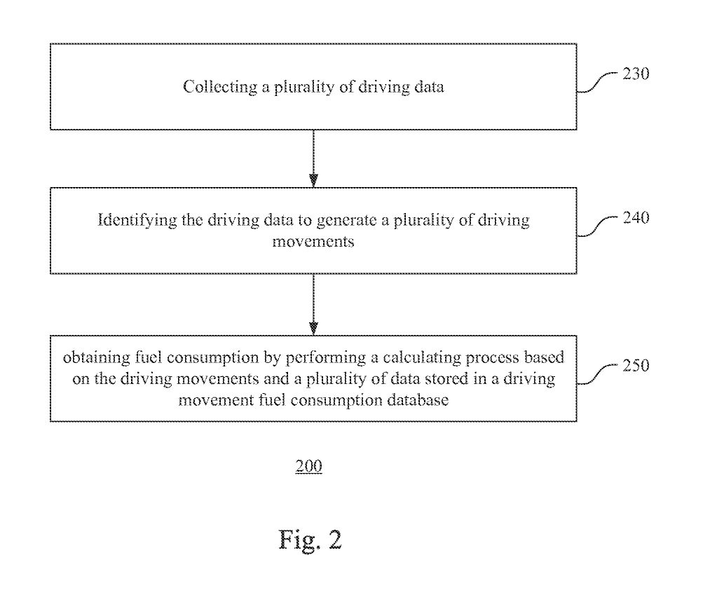

In another embodiment of the present invention, as shown in FIG. 1B-2 which schematically shows a circuit block diagram of a driving fuel consumption calculating system according to yet embodiment of the present invention. Compared with FIG. 1B-1, the driving movement identifying module 114 and the driving fuel consumption calculating module 116 of the driving fuel consumption calculation system herein can be arranged to connect to the driving movement fuel consumption database 120.

As shown in FIG. 1B-2, the wireless module 118 is electrically connected to the driving movement data collecting module 112, and the wireless module 130 is electrically connected to the driving movement identifying module 114. In this configuration, the driving movement identifying module 114 can receive the plurality of driving data from the driving movement data collecting module 112 in a wirelessly way. Sequentially, the rest operation is described above, and accordingly, a detail description in this regard will be omitted herein for the sake of brevity. However, the present invention is not intended to be limited in the embodiment, and the embodiment is merely used for illustration only.

FIG. 1C schematically shows a circuit block diagram of a driving fuel consumption calculating system 110 according to still another embodiment of the present invention. Compared with FIG. 1A, the driving fuel consumption calculation system 110 herein further comprises a driving movement fuel consumption calculating module 113 and a driving movement fuel consumption creating module 115. In configuration, the driving movement fuel consumption creating module 115 is electrically connected to the driving movement fuel consumption calculating module 113 and the driving movement fuel consumption database 120.

In operation, the driving movement fuel consumption calculating module 113 is operable to calculate the fuel consumption of the driving movements, and the driving movement fuel consumption creating module 115 is operable to create the data stored in the driving movement fuel consumption database 120 based on the fuel consumption of the driving movements.

Specifically, the driving fuel consumption calculation system 110 of the present invention can use the driving movement fuel consumption calculating module 113 to calculate the fuel consumption of each driving movement when a car is in the garage. Sequentially, the driving movement fuel consumption creating module 115 can create the data stored in the driving movement fuel consumption database 120 based on the fuel consumption of the driving movements.

In addition, when the condition of the car is changed, for example, the engine oil of the car is changed, the tire of the car is changed, and so on, the driving movement fuel consumption calculating module 113 is applicable to calculate the fuel consumption of each driving movement of the car again, and accordingly, the driving movement fuel consumption creating module 115 can create the data stored in the driving movement fuel consumption database 120 based on the renewed fuel consumption of the driving movements such that the driving fuel consumption calculation system 110 of the present invention can calculate accurate fuel consumption depending on the renewed fuel consumption of the driving movements.

The fuel consumption of the driving movements can be created by the driving fuel consumption calculation system 110 of the present invention beforehand and stored in the driving movement fuel consumption database 120. Hence, the driving fuel consumption calculation system 110 can use the driving movement data collecting module 112 to collect instant driving movement data, and the driving movement data is then identified by the driving movement identifying module 114 to obtain the driving movements. Consequently, the driving fuel consumption calculating module 116 calculates fuel consumption during driving a car for a distance based on the data stored in the driving movement fuel consumption database 120 beforehand.

FIG. 1D-1 schematically shows a circuit block diagram of a driving fuel consumption calculating system according to yet another embodiment of the present invention.

In one embodiment of the present invention, as shown in FIG. 1D-1, it schematically shows a circuit block diagram of a driving fuel consumption calculating system 110 according to yet another embodiment of the present invention. Compared with FIG. 1C, the driving fuel consumption calculation system 110 further comprises a wireless module 118. The wireless module 118 is electrically connected to the driving fuel consumption calculating module 116 and the driving movement fuel consumption creating module 115. The driving movement fuel consumption database 120 herein is electrically connected to the wireless module 130 not connected to the driving fuel consumption calculating module 116 and driving movement fuel consumption creating module 115.

Compared with FIG. 1C, in operation, the driving fuel consumption calculating module 116 can connect to the wireless module 130 wirelessly through the wireless module 118 to obtain the data stored in the driving movement fuel consumption database 120 from the driving movement fuel consumption database 120. Sequentially, the driving fuel consumption calculating module 116 obtains fuel consumption by performing a calculating process based on the driving movements and a plurality of data. In addition, the driving movement fuel consumption creating module 115 is operable to create a plurality of fuel consumption date of driving movements according to the fuel consumption of the driving movements. The driving movement fuel consumption creating module 115 is connected to the wireless module 130 wirelessly through the wireless module 118 to store the fuel consumption data of the driving movements in the driving movement fuel consumption database 120.

In another embodiment of the present invention, as shown in FIG. 1D-2 which schematically shows a circuit block diagram of a driving fuel consumption calculating system according to still another embodiment of the present invention, compared with FIG. 1D-1, the driving movement identifying module 114 and the driving fuel consumption calculating module 116 of the driving fuel consumption calculation system herein can be arranged to connect to the driving movement fuel consumption database 120.

As shown in FIG. 1D-2, the wireless module 118 is electrically connected to the driving movement data collecting module 112 and the driving movement fuel consumption creating module 115. In this configuration, the driving movement identifying module 114 can receive the plurality of driving data from the driving movement data collecting module 112 in a wirelessly way. Sequentially, the rest operation is described above, and accordingly, a detail description in this regard will be omitted herein for the sake of brevity. However, the present invention is not intended to be limited in the embodiment, and the embodiment is merely used for illustration only.

In another embodiment of the present invention, the data stored in the driving movement fuel consumption database 120 is selected from the group consisting of a vehicle fuel consumption data, a driving movement fuel consumption of a driver, and a fuel consumption data during road driving.

Specifically, the driving movement fuel consumption database 120 can store fuel consumption of different kinds of cars, fuel consumption of driving movements of different drivers, and fuel consumption of driving on different roads, so as to make the driving fuel consumption calculation system 110 of the present invention further calculate accurate fuel consumption based on different detailed conditions.

FIG. 2 schematically shows a flow diagram of a method 200 for calculating fuel consumption during driving according to an embodiment of the present invention. As shown in the figure, the method for calculating fuel consumption during driving 200 comprises the steps of collecting a plurality of driving data (step 230); identifying the driving data to generate a plurality of driving movements (step 240); and obtaining fuel consumption by performing a calculating process based on the driving movements and a plurality of data stored in a driving movement fuel consumption database (step 250).

Referring to step 230, a plurality of driving data can be collected by the driving movement data collecting module 112. In step 240, the driving data are then identified by the driving movement identifying module 114 to generate a plurality of driving movements.

In addition, in step 250, the fuel consumption can be obtained by the driving fuel consumption calculating module 116 by performing a calculating process based on the driving movements and a plurality of data stored in a driving movement fuel consumption database 120.

Hence, the problems as follows can be solved. A conventional electronic control unit cannot provide driving fuel consumption record analysis data, and driving movements are not correlated with fuel consumption data such that it is not accurate to calculate the fuel consumption.

In one embodiment, the method for calculating fuel consumption during driving 200 comprises the steps of calculating fuel consumption of a plurality of driving movements (step 210); creating data stored in the driving movement fuel consumption database based on the fuel consumption of the driving movements (step 220).

It is noted that the steps 210 to 220 are intended as illustrative only to describe an optional embodiment of the present invention, those skilled in the art can selectively adopt proper steps to perform the embodiment of the present invention depending on actual requirements.

In step 210, the fuel consumption of the driving movements can be calculated by the driving movement fuel consumption calculating module 113.

In step 220, the data stored in the driving movement fuel consumption database can be created by the driving movement fuel consumption creating module 115 based on the fuel consumption of the driving movement.

Specifically, the method 200 for calculating fuel consumption during driving of the present invention can calculate the fuel consumption of each driving movement when a car is in the garage by the driving movement fuel consumption calculating module 113. Sequentially, the data stored in the driving movement fuel consumption database 120 can be created by the driving movement fuel consumption creating module 115 based on the fuel consumption of the driving movements.

Hence, the method 200 for calculating fuel consumption during driving of the present invention can create the fuel consumption of the driving movements beforehand, and the fuel consumption of the driving movements can be stored in the driving movement fuel consumption database 120. Therefore, the method 200 for calculating fuel consumption during driving can collect instant driving movement data by the driving movement data collecting module 112, and the driving movement data is then identified by the driving movement identifying module 114 to obtain the driving movements. Consequently, the fuel consumption during driving a car for a distance is calculated by the driving fuel consumption calculating module 116 based on the data stored in the driving movement fuel consumption database 120 beforehand.

In one embodiment of the present invention, the driving data are selected from the group consisting of a vehicle speed, a vehicle acceleration, and a vehicle angular speed. In another embodiment of the present invention, the step of collecting the driving data as mentioned in step 230 comprises the step of: collecting the driving data by a on-board diagnostics, a global positioning system, or a driving movement sensing system.

The driving movement identifying module 114 herein can be used to identify whether the driving movement is to brake a car, start a car, make a L/R turn, make a U turn, make a circular ring turn, stop a car, idle a car, change lane, accelerate a car, brake a car urgently, stop a car urgently, make a turn urgently, accelerate a car urgently, overtake another car, curb parking, or back a car by identifying a vehicle speed, a vehicle accelerate, and a vehicle angular speed when performing a driving movement based on an identification rule. Sequentially, owing to fuel consumption of the driving movements stored in the driving movement fuel consumption data beforehand such as fuel consumption of braking a car, fuel consumption of starting a car, fuel consumption of making a L/R turn, the driving fuel consumption calculating module 116 can be used to calculate fuel consumption during driving a car for a distance based on the driving movements and a plurality of data stored in the driving movement fuel consumption database 120.

In yet another embodiment of the present invention, the data stored in the driving movement fuel consumption database 120 is selected from the group consisting of a vehicle fuel consumption data, a driving movement fuel consumption of a driver, and a fuel consumption data during road driving.

Specifically, the driving movement fuel consumption database 120 can store fuel consumption of different kinds of cars, fuel consumption of driving movements of different drivers, and fuel consumption of driving on different roads, so as to make the driving fuel consumption calculation system 110 of the present invention further calculate accurate fuel consumption based on different detailed conditions.

Those having skill in the art will appreciate that the method 200 for calculating fuel consumption during driving can be performed with software, hardware, and/or firmware. For example, if an implementer determines that speed and accuracy are paramount, the implementer may opt for a mainly hardware and/or firmware implementation; alternatively, if flexibility is paramount, the implementer may opt for a mainly software implementation; or, yet again alternatively, the implementer may opt for some combination of hardware, software, and/or firmware. Those skilled in the art will recognize that optical aspects of implementations will typically employ optically oriented hardware, software, and or firmware.

In addition, those skilled in the art will appreciate that each of the steps of the method 200 for calculating fuel consumption during driving named after the function thereof is merely used to describe the technology in the embodiment of the present invention in detail but not limited to. Therefore, combining the steps of said method into one step, dividing the steps into several steps, or rearranging the order of the steps is within the scope of the embodiment in the present invention.

In view of the foregoing embodiments of the present invention, many advantages of the present invention are now apparent. The embodiment of the present invention provides a method for calculating fuel consumption during driving and a driving fuel consumption calculation system, so as to solve the problems as follows. A conventional electronic control unit cannot provide driving fuel consumption record analysis data. Driving movements are not correlated with fuel consumption data such that it is not accurate to calculate the fuel consumption.

In addition, the driving fuel consumption calculation system 110 and the method 200 for calculating fuel consumption during driving of the present invention can create the fuel consumption of the driving movements beforehand, and the fuel consumption of the driving movements can be stored in the driving movement fuel consumption database 120. Therefore, the method 200 for calculating fuel consumption during driving can collect instant driving movement data by the driving movement data collecting module 112, and the driving movement data is then identified by the driving movement identifying module 114 to obtain the driving movements. Consequently, the fuel consumption during driving a car for a distance is calculated by the driving fuel consumption calculating module 116 based on the data stored in the driving movement fuel consumption database 120 beforehand.

Furthermore, the driving fuel consumption calculation system 110 and the method 200 for calculating fuel consumption during driving of the present invention can use the driving movement fuel consumption database 120 to store fuel consumption of different kinds of cars, fuel consumption of driving movements of different drivers, and fuel consumption of driving on different roads, so as to make the driving fuel consumption calculation system 110 of the present invention further calculate accurate fuel consumption based on different detailed conditions.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention, and the scope thereof is determined by the claims that follow.

What is claimed is:

1. A method for calculating fuel consumption during driving, comprising:
collecting a plurality of driving data;
identifying the driving data to generate a plurality of driving movements; and
obtaining fuel consumption by performing a calculating process based on the driving movements and a plurality of data stored in a driving movement fuel consumption database.

2. The method for calculating fuel consumption during driving according to claim 1, further comprising:
calculating the fuel consumption of the driving movements; and
is creating the data stored in the driving movement fuel consumption database based on the fuel consumption of the driving movements.

3. The method for calculating fuel consumption during driving according to claim 1, wherein the driving data are selected from the group consisting of a vehicle speed, a vehicle acceleration, and a vehicle angular speed.

4. The method for calculating fuel consumption during driving according to claim 1, wherein the step of collecting the driving data comprises:
collecting the driving data by a on-board diagnostics, a global positioning system, or a driving movement sensing system.

5. The method for calculating fuel consumption during driving according to claim 1, wherein the data stored in the driving movement fuel consumption database are selected from the group consisting of vehicle fuel consumption data, driving movement fuel consumption of a driver, and fuel consumption data of a road driving.

6. A driving fuel consumption calculation system, comprising:
a driving movement data collecting module operable to collect a plurality of driving data;
a driving movement identifying module operable to identify the driving data to generate a plurality of driving movements; and
a driving fuel consumption calculating module operable to obtain fuel consumption by performing a calculating process based on the driving movements and a plurality of data stored in a driving movement fuel consumption database.

7. The driving fuel consumption calculation system according to claim 6, further comprising:
a driving movement fuel consumption calculating module operable to calculate the fuel consumption of the driving movements; and
a driving movement fuel consumption creating module operable to create the data stored in the driving movement fuel consumption database based on the fuel consumption of the driving movements.

8. The driving fuel consumption calculation system according to claim 6, wherein the driving data are selected from the group consisting of a vehicle speed, a vehicle acceleration, and a vehicle angular speed.

9. The driving fuel consumption calculation system according to claim 6, wherein the driving data are collected by the driving movement data collecting module from a on-board diagnostics, a global positioning system, or a driving movement sensing system.

10. The driving fuel consumption calculation system according to claim 6, wherein the data stored in the driving movement fuel consumption database are selected from the group consisting of vehicle fuel consumption data, driving movement fuel consumption of a driver, and fuel consumption data of a road driving.
